(19) United States
(12) Patent Application Publication
(10) Pub. No.: US 2023/0032213 A1
(43) Pub. Date: Feb. 2, 2023

(54) Ice Block Removal Tool

(71) Applicant: Jody Dryman, Norton Shores, MI (US)

(72) Inventor: Jody Dryman, Norton Shores, MI (US)

(21) Appl. No.: 17/865,483

(22) Filed: Jul. 15, 2022

Related U.S. Application Data
(60) Provisional application No. 63/226,839, filed on Jul. 29, 2021.

(51) Int. Cl. A01K 97/01

(52) U.S. Cl. CPC A01K 97/01

(57) ABSTRACT

The present invention relates generally to the field of ice block removal tools and ice fishing accessories, and comprises first and second 4-way connectors and a first and second set of bars. Each of the connectors receives a chain that passes entirely through the 4-way connector, and a D-shaped ring shackle attaches to the chain, thereby prohibiting the chain from disengaging from the tool. Once assembled, one mechanism is lowered into an opening in the ice far enough below the ice for the bars to rotate to a parallel position below the ice. Once in position, the user is able to pull in an upward motion and dislodge the block of ice, thereby removing a section of the ice for various activities such as ice fishing.

### CROSS-REFERENCE TO RELATED APPLICATION

The present application claims priority to, and the benefit of, U.S. Provisional Application No. 63/226,839, which was filed on Jul. 29, 2021 and is incorporated herein by reference in its entirety.

### FIELD OF THE INVENTION

The present invention relates generally to the field of accessories or tools for use when ice fishing or for harvesting ice. More specifically, the present invention relates to a multi-purpose ice block removal tool for use in removing ice blocks or other cut outs from frozen lakes, rivers and other bodies of water. The tool uses a connected group of lifting bars, which are connected via a 4-way connector and bars. The tools or mechanisms are connected by a chain secured by D-ring shackles. The 4-way connectors are preferably hollow and circular, and allow for the threading of bars on opposite sides of the 4-way connectors. The bars may be filled with foam insulation such that in the event that the tool is dropped into the water, the tool will float and be easily recovered. The bars would be of a shape and size to mate with the 4-way connectors. The tool further receives a chain that passes entirely through each of the 4-way connectors. A D-ring shackle attaches to the chain in order to stop the chain from disengaging from the connectors. Accordingly, the present disclosure makes specific reference thereto. Nonetheless, it is to be appreciated that aspects of the present invention are also equally applicable to other like applications, devices and methods of manufacture.

### BACKGROUND

By way of background, typically when an individual participates in ice fishing, he or she must cut a hole in the ice in order to cast a fishing line to reach the fish that are below the level of the ice. In order to access the fish, a person must either cut a sufficiently large hole, such as with an ice auger, or cut and remove a block of ice such as with the use of a saw. The ice may be cut in different shapes and sizes. Currently, in order to remove a block of ice, an individual must use his or her hands, a crow bar, lever, or other device that will dislodge a portion of the ice in order to be able to move and lift the block of ice out of the water. Alternatively, a person may need to haul a large auger or other cutting device in order to cut a hole to an appropriate size. The present invention may also be used for harvesting blocks of ice for cooling purposes or to build igloos, sporting tracks or provide other wintertime demonstrations.

Generally, when a person uses his or her hands to remove a block of ice, the process may cause his or her hands to become wet, cold and generally uncomfortable. The person may also have to overexert himself or herself such that he or she may no longer be able to enjoy the fishing activity due to extreme tiredness. In addition, a person may slip and fall while attempting to remove a heavy block of ice, thereby causing injury.

Therefore, there exists a long-felt need in the art for an improved device to remove blocks of ice for harvesting as well as to allow access to the water for ice fishing. There also exists a long-felt need in art for an improved multi-purpose ice fishing and ice harvesting device that allows a user to remove a block of ice easily, efficiently and quickly. Further, there exists a long-felt need in the art for a multi-purpose ice fishing or harvesting device that does not require a user to use his or her hands to remove a block of ice. Still further, there exists a long-felt need in the art for a multi-purpose ice fishing or harvesting device that does not require a user to transport a large, heavy and cumbersome cutting tool to cut an opening large enough to ice fish or engage in other wintertime activities.

The subject matter disclosed and claimed herein, in one embodiment thereof, comprises a multi-purpose ice block removal tool. The tool has two mechanisms. Each mechanism has a 4-way connector and bars extending outwardly from the connectors. The bars are preferably circular, with threads located on one end of each bar. Each of the bars may be filled with a foam or other material, such as polyurethane, polystyrene or StyrofoamⓇ, to provide a flotation capability in the event the tool is dropped into the water. In addition, the exterior surface of the bars may be provided with projections, spikes or the like which may help in gripping and securing the ice block as it is being removed from the water. The bars preferably attach to the 4-way connector by threading into openings located exactly opposite each other. The 4-way connector further receives a chain that passes through the two openings where the bars are not located. The mechanisms are connected through a chain which is locked in place with D-ring shackles. The mechanisms are positions sufficiently apart from each other to allow one mechanism to be lowered through an opening in the block of ice and allowing the second mechanism to be grasped by the user to lift the block of ice from the water.

In this manner, the multi-purpose ice block removal tool of the present invention accomplishes all of the forgoing objectives and provides a device to allow a user to remove a block of ice without having to place his or her hands in the water to remove the block of ice. Further, the device allows a user to easily transport and store the device, and does not need a large bulky cutting tool such as an ice auger. The device of the present invention is also user-friendly and lightweight, while still capable of providing the strength needed to lift the weight of a block of ice. In addition, the device is also extremely versatile, as it can be used to remove a variety of items such that when cut, there is no handle or easily accessible way to remove the cut portion from the water.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subj ect matter disclosed and claimed herein, in one embodiment thereof, comprises a multi-purpose ice block removal tool. The invention has at least two couplings. Each coupling includes a 4-way connector and removable bars. The mechanisms are positions sufficiently apart from each other to allow one portion of the tool to be lowered through a block of ice and allow the second portion of the tool to be grasped by the user in order to lift the block of ice out of the water.

In a preferred embodiment, the bars are circular and threaded on one end. The bars preferably attach to the 4-way connector or coupling by threading into openings located exactly opposite each other. However, the bars may be attached through any suitable connecting or fastening mechanism including, without limitation, threads, fasteners, adhesives, friction, interference fits, and various combinations thereof. In addition, the bars may also be permanently affixed to the 4-way connector whereby the bars are unable to detach from the 4-way connector. The bars may also be of a material that is retractable and capable of compressing towards and inside the 4-way connector to allow for easier storage and handling. The bars may be filled with a floatation material to allow the tool to float in the event it is inadvertently dropped into the water.

Further, the bars are preferably constructed of metal but may be constructed of steel, copper, brass, titanium, aluminum, stainless steel, galvanized steel or other suitable material. The length of the bars may vary to meet the needs of the user. The circumference of the bars may also vary, but should be a shape and size suitable to fasten to the 4-way connector.

The couplings are connected through a chain which is locked in place with D-ring shackles or other fasteners. The 4-way connect receives a chain that passes entirely through the two openings, vertical openings where the bars are not located as the bars are placed in the horizontal openings of the cross-shaped coupling. The D-ring shackle is preferably a “U” shape, whereby a pin is inserted into the ends, preventing the D-ring shackle from detaching from the chain. Alternatively, bolts, cotter pins, links or other connecting devices may be used to secure the mechanisms to the chain.

Accordingly, the multi-purpose ice block removal tool of the present invention is particularly advantageous as it allows a user to remove a block of ice with less physical force or strength than opposed to using the user’s hands. Further, the device allows a user to limit the risk of accidents that may be caused by using a person’s hands to handle blocks of ice. The device is also extremely versatile as it can be used to remove other items that do not have readily assessable handles or other removal means.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a multi-purpose ice fishing or ice block removal tool of the present invention being used to lift a block of ice in accordance with the disclosed architecture;

FIG. 2 illustrates a cross-sectional view of one potential embodiment of a multi-purpose ice block removal tool and ice fishing accessory of the present invention in accordance with the disclosed architecture;

FIG. 3 illustrates a perspective view of one potential embodiment of a multi-purpose ice block removal tool and ice fishing accessory of the present invention in accordance with the disclosed architecture;

FIG. 4A illustrates a close-up perspective view of one potential embodiment of a multi-purpose ice block removal tool and ice fishing accessory of the present invention in accordance with the disclosed architecture;

FIG. 4B illustrates a cross-sectional view of a bar or pipe that is used with the multi-purpose ice block removal tool of the present invention, wherein the bar or pipe contains a floatation material;

FIG. 4C illustrates a front perspective view of the threaded ends of the pipe or bar and the cross-shaped coupling; and

FIG. 5 illustrates a top perspective view of one potential embodiment of a multi-purpose ice block removal tool and ice fishing accessory of the present invention in use in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved multi-purpose ice block removal tool and ice fishing accessory. There also exists a long-felt need in art for an improved multi-purpose ice block removal tool and ice fishing accessory capable of lifting a block of ice from the water where it was cut. Further, there exists a long-felt need in the art for an improved multi-purpose ice block removal tool and ice fishing accessory that can easily be inserted and passed entirely through a cut hole in an area of the ice. Still further, there exists a long-felt need in the art for an improved multi-purpose ice block removal tool and ice fishing accessory that allows a user to lift a block of ice without having to have a prolonged touching of the ice or water with the user’s hands. Yet further still, there exists a long-felt need in the art for an improved multi-purpose ice block removal tool and ice fishing accessory that is capable of lifting a block of ice and is also capable of being easily transportable.

The present invention, in one exemplary embodiment, is comprised of a multi-purpose ice block removal tool and ice fishing accessory primarily comprised of two identical coupling mechanisms having a cross shape and connected to one another by a chain. Each mechanism is comprised of a 4-way, cross-shaped connector and a plurality of bars. The 4-way connectors are preferably cylindrical, and capable of receiving bars in the horizontal openings of the connectors and a chain in the vertical openings of the chain. In addition, the 4-way connectors have four openings generally positioned at 90 degree angles to each other thereby forming a “plus” sign or cross-shaped configuration.

The 4-way connector has a fastening mechanism to secure the bars into the openings to thereby prevent the bars from detaching from the 4-way connector. Furthermore, the bars are manufactured from a suitably durable material such as metal, titanium, aluminum, steel (stainless, galvanized) or other similar material capable of supporting up to 500 pounds. The bars are of a size and shape to mate with the 4-way connector openings.

The cross-shaped connector mechanisms are connected to one another by a chain. The chain has a series of interconnected links. The chain is preferably at least four feet in length while remaining adjustable, such as through the use of removable links, to meet the height of the user and the thickness of the block of ice. However, the mechanisms may also be connected by a rope, twine, cable or other mechanism suitable for the intended purpose.

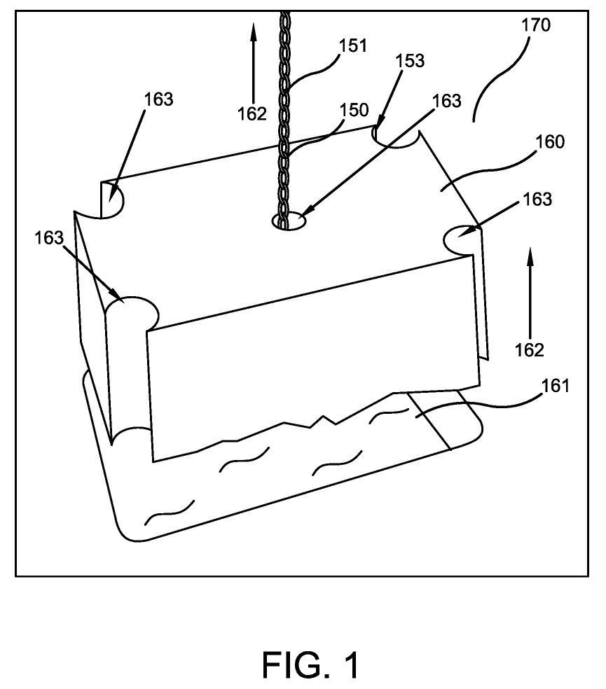

Referring initially to the drawings, FIG. 1 illustrates a perspective view of one embodiment of a multi-purpose ice block removal tool and ice fishing accessory 100 of the present invention showing the device 100 supporting a block of ice 160 that has been removed from the water or ice field. More specifically, the multi-purpose ice block removal tool and ice fishing accessory 100 of the present invention is strong enough to support the weight of a block of ice 160 or up to 500 pounds. The block of ice 160 may be located in any venue 170 such as a lake, pond, river, stream, other body of water, a field that may have been flooded to create a harvestable patch of ice or any other type of location suitable for ice fishing or ice harvesting.

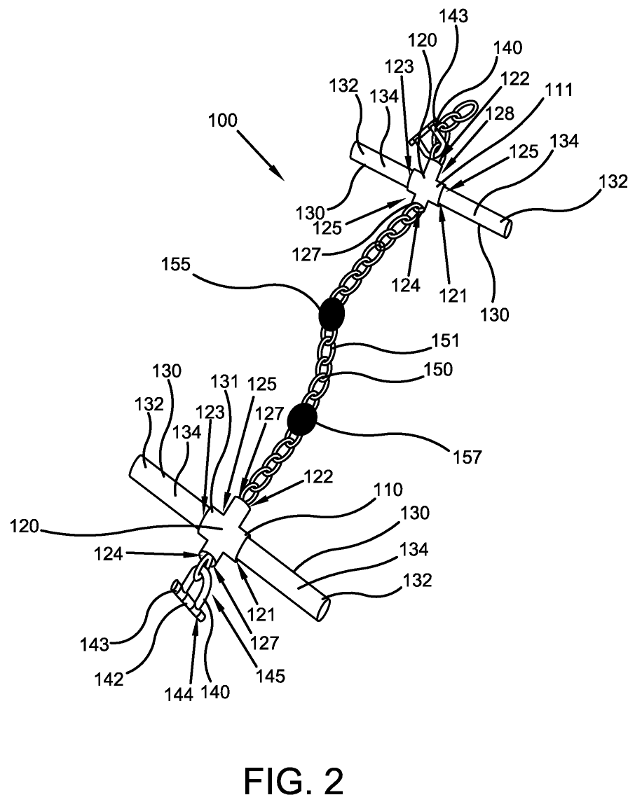

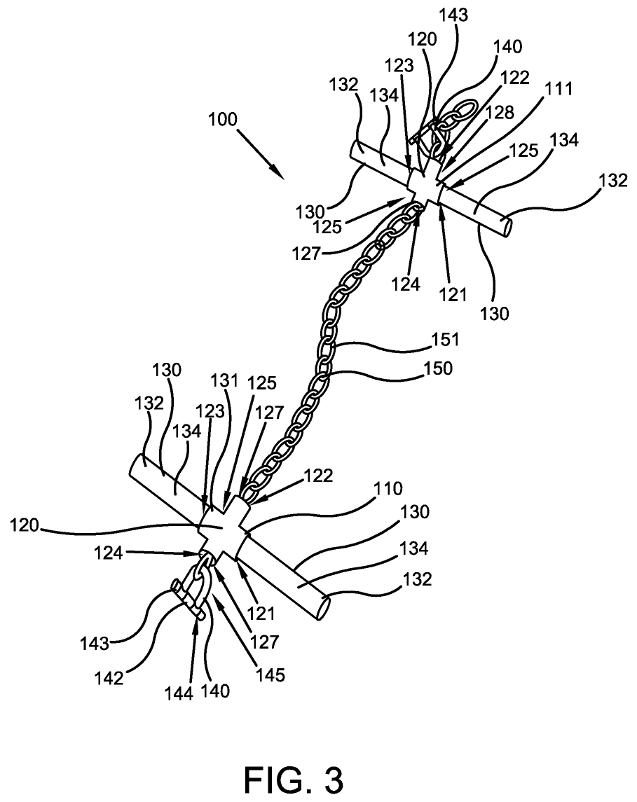

The multi-purpose ice block removal tool and ice fishing accessory 100 has two identical, or first and second coupling mechanisms, first mechanism A 110 and second mechanism B 111. The first and second mechanisms 110, 111 are a 4-way connector 120 (shown in FIGS. 2-4) and bars 130 (shown in FIGS. 2-4). First mechanism A 110 and second mechanism B 111 are connected through a chain 150 (shown in FIGS. 2 and 3). As explained more fully below, when in use, first mechanism A 110 is positioned underneath 161 the block of ice 160 and of suitable strength to dislodge and lift the block of ice 160 in an upward direction 162. As shown in FIG. 1, the device 100 is in use with the block of ice 160 completely dislodged from the remaining ice in the venue 170 and suspended in mid-air.

FIGS. 2 and 3 illustrate a perspective view of one potential embodiment of a multi-purpose ice block removal tool and ice fishing accessory 100 of the present invention in accordance with the disclosed specification. More specifically, the first and second coupling mechanisms 110, 111 are each a 4-way connector 120 and bars 130. The 4-way connector 120 has four separate openings 121, 122, 123, 124 with each opening positioned at 90 degree angles 125 to each other along the same plane. Each opening 121, 122, 123, 124 is preferably hollow, but may be any configuration to allow bars 130 to be inserted or fastened into two opposing openings 121, 122, 123, 124, opposite one another and a chain 150 to pass completely through the 4-way connector 120. In a preferred embodiment, at least two of the four separate openings 121, 122, 123, 124 have threads 126 therein for receipt of the first end 131 of the bar 130, as explained more fully below. The chain 150 may be provided with one or more removable links 155 and 157 which allow for the user to adjust the length of the chain to accommodate different depths of ice. In this way, the tool can be adjusted as needed so that the tool maintains a tight-gripping association with the ice block to be removed, and there is not a large portion of chain exposed either above or below the ice which may make the tool a bit more unwieldy. A portion of the chain extends beyond each end of the cross-shaped openings so that a fastener can be applied to set the length of the chain.

The bars 130 have a first end 131, second end 132 and bar threads 133. In a preferred embodiment, two bars 130 are threaded into two separate openings 121, 122, 123, 124 that are located opposite each other. The bars 130 are preferably fastened using bar threads 133, however, it is not so limiting and any suitable connecting or fastening mechanism including, without limitation, fasteners, adhesives, friction, or interference fits, etc. may be used. Alternatively, the 4-way connector 120 and bars 130 may be formed from a single member that has two ends protruding in opposite directions from the 4-way connector 120, thereby creating a single substantially longer cross-member on a single plane. Further, the bars 130 may also be permanently-affixed to the 4-way connector 120 whereby the bars 130 are unable to detach from the 4-way connector 120. The bars 130 may also be of a material that is retractable and capable of compressing towards the 4-way connector 120 to allow for easier storage and transportation. In addition, the length of the bars 130 may vary to meet the needs of the user and the circumference of the bars may also vary but should be of a shape and size suitable to fasten to the 4-way connector 120.

The 4-way connector 120 is further comprised of a hollow space 127 that extends the length of the 4-way connector 120 capable of receiving a chain 150 or other similar mechanism and allows the chain 150 to pass completely through two openings 121, 122, 123, 124 located opposite each other. Alternatively, the 4-way connector 120 may have a chain 150 that is permanently-affixed to the 4-way connector 120.

As still further illustrated in FIGS. 2 and 3, the bars 130 have a cylindrical body 134, first end 131 and second end 132. The first end 131 has bar threads 133. The bar 130 may be any shape and size that meets the needs of the consumer and is capable of passing through hole 163 and supporting the weight of the block of ice 160. The bar 130 is preferably a non-rusting or rust-resistant material or metal of suitable strength, but may also be comprised of steel (stainless, galvanized), copper, brass, titanium, aluminum, or other suitable material. The bar threads 133 are attached to the threads 126 in two of the openings 121, 122, 123, 124 of the cross-shaped connector by rotating the bar 130 in a clockwise motion 135 until the bar 130 is secure. Alternatively, when the bars 130 are removed from the 4-way connector 120, the bars 130 would be turned in a counterclockwise motion 136 until each bar is completely detached from the corresponding opening 121, 122, 123, 124. The hollow space 127 of the opening 121, 122, 123, 124 has corresponding threads 126 molded into the bars 130. The bar 130 may also be attached through other means such as adhesives, welding, clamps, pins or other suitable means.

As further illustrated in FIGS. 2 and 3, the mechanisms 110, 111 are connected together by a chain 150. Once two bars 130 are attached to the 4-way connector 120 through opposing openings 121, 122, 123, 124, a chain 150 is inserted into the two openings 121, 122, 123, 124 and passed through the openings and are not impeded by the bar 130. In a preferred embodiment, a chain 150 would have a series of elongated connected links 151 but it is not so limited and may be comprised of a rope, cable, twine, or other suitable material. The chain may have one or more removable links 155 and 157 to allow the user to adjust the length of the chain and thereby the tool itself. Portions of the chain may also be colored, such as with a neon or other bright colors so that with clear ice the chain may be visible. The chain 150 is preferably passed through the entire length of the 4-way connector 120 and protrudes out one opening 121, 122, 123, 124 at a sufficient length for a D-ring shackle 140 to attach, as explained further below. The length of the chain 150 between the mechanisms 110, 111 is of a length that allow mechanism A 110 to be positioned under a block of ice 160, the chain 150 to extend through the auger hole 163 and extend an additional amount to mechanism B 111 and meets the needs of the user.

As further illustrated in FIGS. 2 and 3, the chain 150 is secured by a D-ring shackle 140, thereby preventing the chain 150 from being removed from the openings 121, 122, 123, 124. In a preferred embodiment, the D-ring shackle 140 is a solid metal or other suitably strong alloy that is bent at such an angle as to create a U shape 145. Each end 143 of the U shape 145 is preferably hollow, and capable of receiving a pin 142. The pin 142 is passed through the openings 144 at each end 143 causing the D-ring shackle 140 to lock in place. Once inserted, the pin 142 would prevent the chain 150 from disengaging from the D-ring shackle 140. While a D-ring shackle 140 is the preferred mechanism to prevent the chain 150 from being removed from the openings 121, 122, 123, 124, any suitable fastening mechanism may be used including, without limitation, bolts, cotter pins, links, or other connecting devices. The D-ring shackle 140 may be placed at any position along the chain 150 to meet the needs of the user and may be adjusted as needed to the thickness of the block of ice 160. Further, the overall length of the chain 150 may be any suitable length in any embodiment to meet the wants and/or needs of a user.

As shown in FIGS. 2 and 3, the process of affixing the bars 130 and chain 150 to the 4-way connector 120 is repeated, thereby resulting in two identical mechanisms 110, 111 positioned proportionately to each other and connected by a chain 150 of a length suitable for the purpose of the device 100.

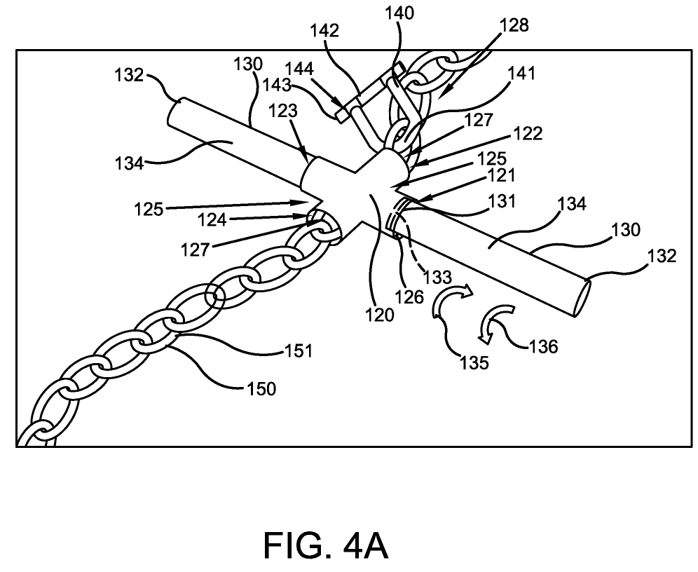

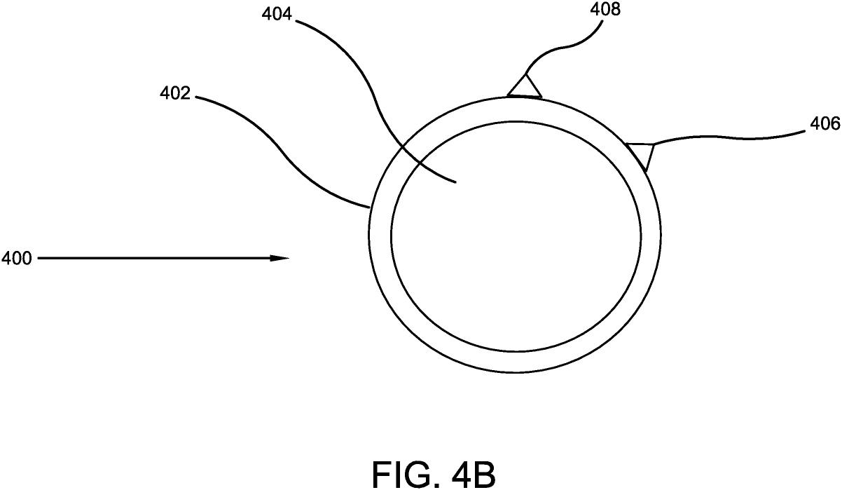

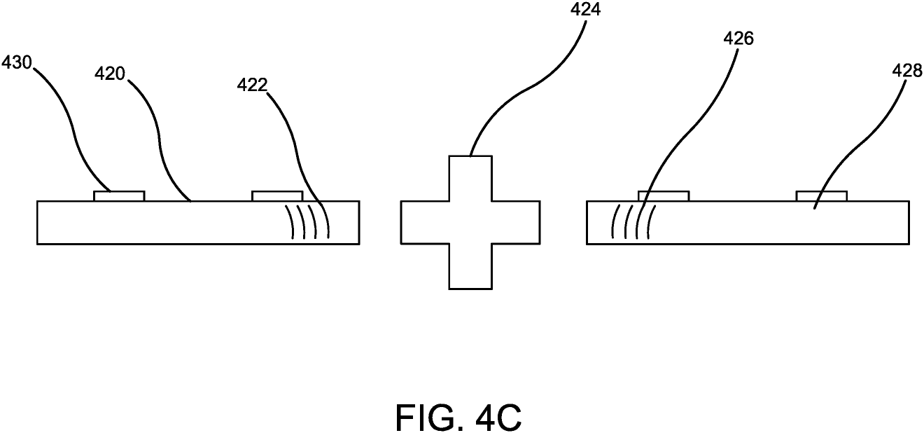

FIG. 4A illustrates a close-up perspective view of one potential embodiment of a multi-purpose ice block removal tool and ice fishing accessory 100 of the present invention in accordance with the disclosed specification. Additionally, as noted above, the multi-purpose ice block removal tool and ice fishing accessory 100 has a first mechanism A 110 and second mechanism B 111. As best shown in FIG. 4A, the chain 150 passes through two openings 121, 122, 123, 124 of the second mechanism B 111, thereby allowing the second mechanism B 111 to be positioned along the length of the chain 150.

FIG. 4A further illustrates a D-ring shackle 140 is affixed to the chain 150 on the outer side 128 of the 4-way connector 120, thereby prohibiting the chain 150 from being removed from the second mechanism B 111. As further shown, the D-ring shackle 140 may be positioned at any point along the chain 150 to allow the user to adjust the length of the chain 150 to meet the needs of the user. In addition, removable links 155 and 157 may be provided as needed to provide additional adjustment of the chain. FIG. 4 shows the chain 150 having a series of interconnect links 151 resulting in a flexible length of metal that is strong when under tension. FIG. 4A further illustrates the bars 130 affixed to the 4-way connector 120 and extending to a length suitable to lift a block of ice 160. The bars 130 may be any length that meets the needs of the user.

FIG. 4B provides a cross-sectional view of the bar 400 used in connection with the present invention. Bar 400 has the outer shell 402 and an inner area 400 which is filled with a floatation material such as polyurethane, polystyrene, Styrofoam® or combinations thereof to aid the user in retrieving the tool in the event the tool inadvertently falls in the water. The bar 400 may also have one or more projections 406 and 408 on the exterior of the shell 402 to prevent the ice block from moving when being lifted from the water. The projections 406 and 408 dig into the ice and provide additional gripping. Alternatively, the projections 406 and 408 can be gripping surfaces to assist the user in holding the tool. The projections 406 and 408 may be hardened projections such as metal, or may be flexible such as a rubber material.

FIG. 4C shows the first bar 420 and second bar 428 with threaded ends 422 and 426, respectively. The threaded ends 422 and 426 are inserted into opposite ends of the cross-shaped connector 424. The bars 420 and 428 may also be provided with fluorescent or brightly colored areas so that the bars can be seen below the water and or ice.

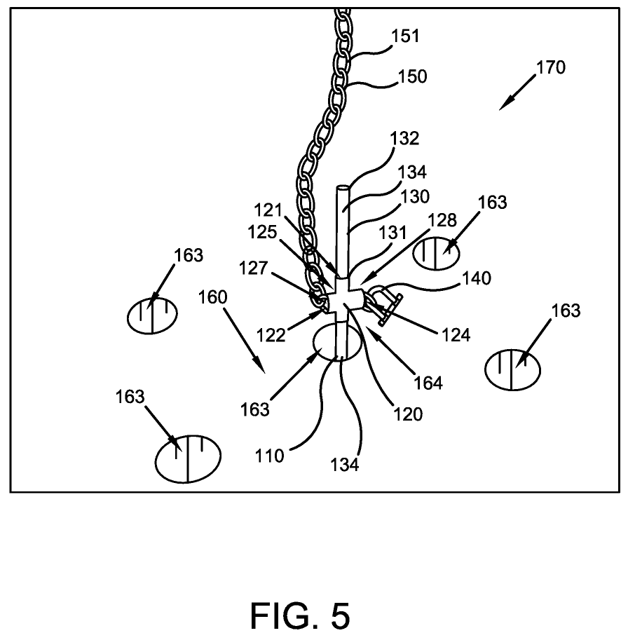

FIG. 5 illustrate a perspective view of one potential embodiment of a multi-purpose ice block removal tool and ice fishing accessory 100 of the present invention in accordance with the disclosed specification showing a portion of the device 100 being inserted in the hole 163 in a block of ice 160. In order to position the device 100 underneath 161 the block of ice 160, holes 163 must first be cut or drilled, such as with a small auger or drill. Once the holes 163 are in place, first mechanism A 110 is turned so the bars 130 are positioned perpendicular 164 to the block of ice 160 and aligned with the holes. As shown in FIG. 5, one bar 130 is then lowered into and through the hole 163. First mechanism A 110 is lowered until both bars 130 completely pass through the block of ice 160 and subsequently located underneath 161 the block of ice 160. At this point, the bars 130 will rotate into a position parallel to the surface and block of ice 160 (not shown). The user will then pull the second mechanism B 111 in an upward direction 162 until first mechanism A 110 connects underneath 161 the block of ice 160 and the chain 150 is taut. The user may shorten the length of the chain if needed to have the bars in contact with a block of ice. Once engaged, the user will continue to pull in an upward direction 152 until the block of ice 160 is dislodged from the remaining ice at the venue 170. First mechanism A 110 is then rotated back to a perpendicular 164 position and removed from the hole 163, or alternatively the block is simply broken at the hole to allow removal of the tool.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “multi-purpose ice fishing device” and “device” are interchangeable and refer to the multi-purpose ice fishing device 100 of the present invention.

Notwithstanding the forgoing, the multi-purpose ice fishing device 100 of the present invention and its various components can be of any suitable size and configuration as is known in the art without affecting the overall concept of the invention, provided that they accomplish the above-stated objectives. One of ordinary skill in the art will appreciate that the size, configuration and material of the multi-purpose ice fishing device 100 as shown in FIGS. 1-5 is for illustrative purposes only, and that many other sizes and shapes of the multi-purpose ice fishing device 100 are well within the scope of the present disclosure. Although the dimensions of the multi-purpose ice fishing device 100 are important design parameters for user convenience, the multi-purpose ice fishing device 100 may be of any size, shape and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An ice block removal tool comprising;
a chain;
a plurality of bars, wherein each of the plurality of bars comprise a threaded end; and
a cross-shaped connector having a plurality of openings, wherein at least a first and a second of the plurality of openings comprise internal threads, wherein a first one of the plurality of bars is secured in the first opening and a second one of the plurality of bars is secured to the second opening that is opposite the first opening, and further wherein the chain is inserted through at least two of the plurality of openings.

2. The ice block removal tool as recited in claim 1, wherein a second cross-shaped connector is provided having four opening.

3. The ice block removal tool as recited in claim 2, wherein a second set of bars is provided and secured in the second cross-shaped connector at opposite sides of the second cross-shaped connector.

4. The ice block removal tool as recited in claim 3, wherein the chain is inserted through the second cross-shaped connector perpendicularly to the second set of bars.

5. The ice block removal tool as recited in claim 1, wherein at least one fastener is provided to hold the chain in position above the cross-shaped connector.

6. The ice block removal tool as recited in claim 1, wherein the chain is provided with at least one removable link.

7. The ice block removal tool as recited in claim 1, wherein the plurality of bars are provided with a floatation material.

8. The ice block removal tool as recited in claim 7, wherein the floatation material is selected from a group consisting of a polyurethane foam, a polystyrene foam and a Styrofoam.

9. The ice block removal tool as recited in claim 1, wherein the plurality of bars are provided with gripping projections positioned thereon.

10. The ice block removal tool as recited in claim 1, wherein at least one of the chain or plurality of bars is provided with neon colors to detect the at least one of the chain or plurality of bars below a layer of ice or a body of water.

11. An ice fishing accessory comprising:
a first cross-shaped connector;
a second cross-shaped connector;
a plurality of bars with two of the plurality of bars being inserted in the first cross-shaped connector in openings opposite one another and an additional two of the plurality of bars being inserted into the second cross-shaped connector in openings opposite one another;
a chain inserted through each of the first and second cross-shaped connectors perpendicularly to the plurality of bars such that a portion of the chain extends beyond an end of each of the first and second cross-shaped connectors; and
a pair of fasteners for holding the chain and first and second cross-shaped connectors in a desired position.

12. The ice fishing accessory as recited in claim 11, wherein the pair of fasteners are D-shaped rings.

13. The ice fishing accessory as recited in claim 11, wherein the plurality of bars include a floatation material in an interior cavity of the plurality of bars.

14. The ice fishing accessory as recited in claim 13, wherein the floatation material is selected from a group consisting of a polyurethane foam, a polystyrene foam and a Styrofoam.

15. The ice fishing accessory as recited in claim 11, wherein at least one of the chain and the plurality of bars is provided with a neon color.

16. The ice fishing accessory as recited in claim 11, wherein the first and second cross-shaped connectors, the chain and the plurality of bars are comprised of a rust-resistant material.

17. The ice fishing accessory as recited in claim 16, wherein the rust-resistant material is selected from a group consisting of a copper, a brass, a titanium, an aluminum, a stainless steel, and a galvanized steel.

18. The ice fishing accessory as recited in claim 11, wherein at least one of the plurality of bars is provided with gripping projections.

19. The ice fishing accessory as recited in claim 18, wherein the gripping projections are comprised of a flexible material.

20. An ice fishing tool comprising:
a first cross-shaped connector having four openings;
a second cross-shaped connector having four openings;
a first pair of bars for use with the first cross-shaped connector, wherein each of the first pair bars are inserted into opposite openings of the first cross-shaped connector;
a second pair of bars for use with the second cross-shaped connector, wherein each of the second pair bars are inserted into opposite openings of the second cross-shaped connector;
a chain inserted through each of the first and second cross-shaped connectors, wherein the chain passes completely through each of the first and second cross-shaped connectors, and further wherein each of the chain, the first and second cross-shaped connectors, the first pair of bars and the second pair of bars are manufactured from a rust-resistant material; and
a D-shaped ring inserted into the chain below at least one of the first and second cross-shaped connectors.
